(19) United States
(12) Patent Application Publication
(10) Pub. No.: US 2011/0222380 A1
(43) Pub. Date: Sep. 15, 2011

(54) OPTICAL DISC APPARATUS, OPTICAL DISC, RECORDING METHOD, AND REPRODUCTION METHOD

(76) Inventors: Motoyuki SUZUKI, Yokohama (JP); Tatsuya Ishitobi, Kawasaki (JP)

(21) Appl. No.: 12/956,198

(22) Filed: Nov. 30, 2010

(30) Foreign Application Priority Data
Mar. 12, 2010 (JP) 2010-055282

(51) Int. Cl. G11B 7/007

(52) U.S. Cl. 369/44.26; G9B/7.029

(57) ABSTRACT

It takes time to read management information and the like from a recording layer in starting reproduction of an optical disc, thus posing a problem of poor usability. Moreover, a light beam needs to be largely moved in a radial direction in recording or reproducing the next layer, thus posing a problem that the time to interrupt recording or reproduction increases. The above-described problems can be resolved by enabling a reference layer to be recorded and reproduced, and recording disc management information and the like in this reference layer, and reproducing this information. Moreover, the reference layer comprises two layers having the spiral directions of the track different from each other, and the reference layer, on which a light beam is focused, is changed according to a layer to be recorded or reproduced in the recording layer.

### INCORPORATION BY REFERENCE

The present application claims priority from Japanese application JP2010-055282 filed on Mar. 12, 2010, the content of which is hereby incorporated by reference into this application.

### BACKGROUND OF THE INVENTION

1. Field of the Invention

The present invention relates to a stacked volumetric optical disc apparatus, an optical disc, and the like for recording and/or reproducing information in a desired depth position of a recording layer while following a track of a reference layer of the optical disc.

2. Description of the Related Art

In recent years, a disc apparatus and optical disc for recording information in a predetermined depth position of a recording layer while following a track of a reference layer have been developed (see EP 2187391A1). Here, information is recorded in a desired depth position in a recording layer utilizing the fact that a micro-reflector (microholography) of a diffraction limit size is formed by causing two light beams to interfere with each other in an identical focus position in a stacked volumetric optical disc.

Moreover, in the micro-reflector technology, JP-A-20009-170036 describes that “In order to be able to highly accurately control the focus position in focusing a light beam onto a target position within a recording layer utilizing two positioning layers provided in an optical disc, an optical disc apparatus 20, with the use of a tracking tilt error signal generation circuit 23F, calculates a tracking tilt error signal SLE1 by adding tracking shift error signals STE1 and STE2 at a ratio corresponding to the depth d of a target position PG according to Formula (6), and based on this tracking tilt error signal, an objective lens 11 is rotationally driven in a tracking tilt direction, so that a focal point Fb1 of a blue light beam Lb1 can be moved in a tracking shift direction so as to be coincident with the target position PG. Furthermore, based on a detection result of the blue light beam Lb1 through the objective lens 11 and an objective lens 12, the angle of a reflection surface 62A of a movable mirror 62 is controlled in the tracking shift direction, so that a focal point Fb2 can be coincident with the focal point Fb1.” (see Abstract of JP-A-2009-170036).

US 2009-0046563 describes that “There is provided an optical information recording/reproducing apparatus capable of promptly recording and/or reproducing information to/from an optical disc capable of recording information in different depth positions in a recording layer. In recording information in a predetermined depth position in the recording layer, the optical information recording/reproducing apparatus records information (e.g., No. 1, or the like) in the relevant predetermined depth position. The optical information recording/reproducing apparatus stores the information about a depth position (the first layer) where information has been recorded or reproduced, so that even if the light flux from the semiconductor laser LD has jumped to a different depth position due to an external disturbance, for example, such as vibration, during the recording/reproduction of information, the light flux can immediately return to the original depth position (the first layer) based on the stored information on the depth position, and the information can be recorded/reproduced without a delay.” (see Abstract of US 2009-0046563).

### SUMMARY OF THE INVENTION

In the above-described micro-reflector system, recording is performed on a predetermined depth position of the recording layer by a micro-reflector while following a track formed in the reference layer, and therefore the recording or reproduction of information to/from the recording layer is performed with the same locus as the spiral of a track of the reference layer. However, in this prior art, for example, if the track of the reference layer is formed in a spiral shape from an inner periphery toward an outer periphery, then the locus which is recorded in the recording layer by the micro-reflector will be similarly formed in the spiral shape from an inner periphery toward the outer periphery for all the layers. Therefore, when the recording or reproduction is finished in the outermost periphery, a light beam needs to be moved to the innermost periphery in recording or reproducing the next layer in the recording layer, thus posing a problem that the time to interrupt recording or reproduction will increase.

The present invention has been made in view of the above-described problems. The present invention is intended, in an optical disc recording/reproducing method for performing recording/reproduction on a recording layer while following a reference layer, to shorten the time required to move a light beam in the radial direction of the disc and reduce the time to interrupt recording or reproduction.

An example of a representative one among the inventions disclosed in the present application is described as follows. That is, an optical disc apparatus recording and/or reproducing information to/from an optical disc, the optical disc comprising a reference layer having a spiral track added with address information and a recording layer capable of recording and/or reproducing information in a predetermined depth position while following the track of the reference layer, the optical disc apparatus comprising: a first light source emitting a first laser beam which is focused on the track of the reference layer; and a second light source emitting a second laser beam which is focused on a predetermined depth position of the recording layer while following the track of the reference layer on which the first laser beam is focused, wherein according to the depth position of the recording layer on which the second laser beam is focused, the first laser beam is focused on the track of a reference layer having a corresponding spiral direction, of two reference layers having the spiral directions of the track different from each other.

According to a representative embodiment of the present invention, in an optical disc recording/reproducing method for performing recording/reproduction on a recording layer while following a reference layer, the time required to move a light beam in the radial direction of a disc can be reduced and the time to interrupt the recording or reproduction can be reduced.

### BRIEF DESCRIPTION OF THE DRAWINGS

FIG. 1 is a block diagram showing a configuration of an optical disc apparatus according to an embodiment of the present invention.

FIG. 2 is a schematic view showing an example of a spiral direction of a track of a reference layer RL of an optical disc.

FIG. 3 is a schematic view showing a relationship between a focus position of a red light beam and a focus position of a blue light beam.

FIG. 4 is a schematic view showing a detailed configuration of an optical disc of a first embodiment.

FIG. 5 is a flowchart showing a detailed procedure of a reproduction processing in the first embodiment.

FIG. 6 is a flowchart showing a detailed procedure of a recording process in the first embodiment.

FIG. 7 is a block diagram showing a configuration of an optical disc apparatus performing recording/reproducing on an optical disc with a recording layer utilizing a two-photon absorption compound in the first embodiment.

FIG. 8 is a flowchart showing a recording/reproduction procedure of an optical disc apparatus in a second embodiment.

FIG. 9 is a flowchart showing a detailed procedure of a reproduction processing in the second embodiment.

FIG. 10 is a flowchart showing a detailed procedure of a recording process in the second embodiment.

### DETAILED DESCRIPTION OF THE EMBODIMENTS

Hereinafter, each embodiment will be described with reference to the accompanying drawings.

### Embodiment 1

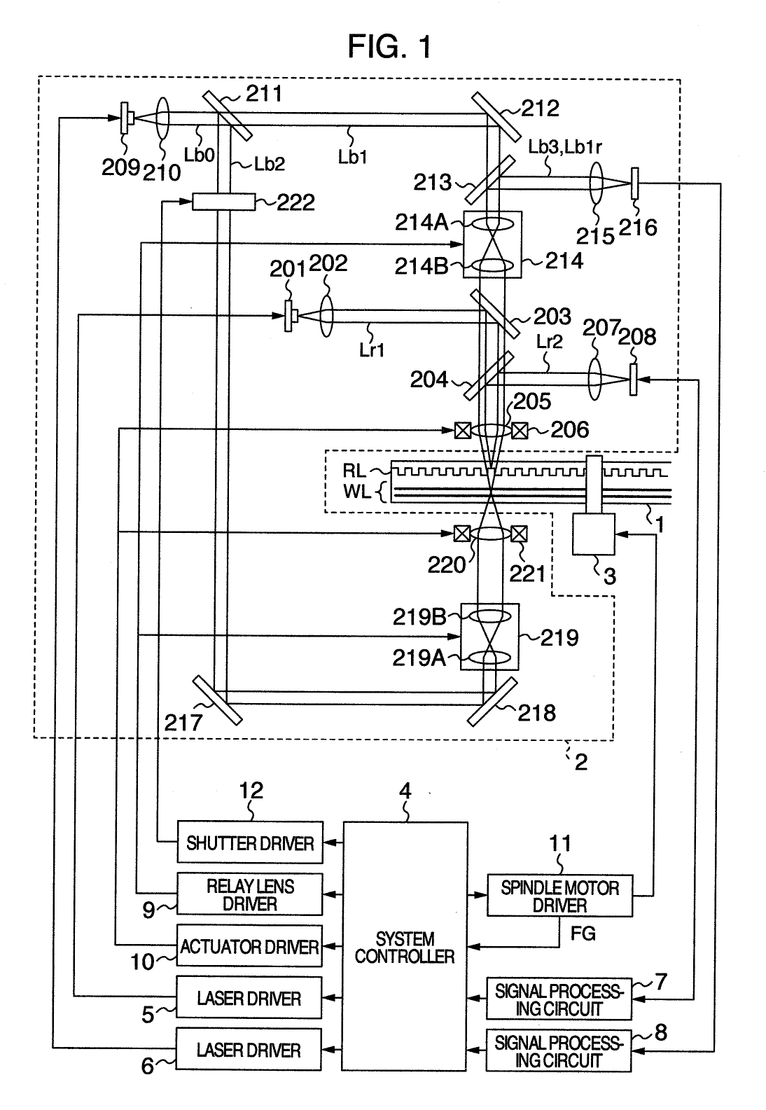

FIG. 1 is a block diagram showing a configuration of an optical disc apparatus in an embodiment of the present invention. An optical disc 1 comprises: a reference layer RL, in which a track is formed as a guide groove having the address of a track for performing recording or reproduction and the disc-specific information for recording or reproducing wobbled therein; and a recording layer WL capable of recording user data in a plurality of depth positions located at different distances from the reference layer RL.

An optical pickup 2 comprises: a servo optical system for performing servo control on the reference layer RL, reproducing the address of the track and the disc-specific information from the wobbled track, and recording/reproducing the information and the like for managing the data to be recorded on the recording layer; and an information optical system for recording/reproducing data in a plurality of depth positions located at different distances from the reference layer RL.

First, the recording operation is described. In the optical pickup 2, a laser 201 for servo is a semiconductor laser emitting a red light beam having a wavelength of approximately 650 [nm]. The laser 201 emits a red light beam Lr1 with a predetermined light quantity based on the control of a laser driver 5 and causes the same to enter a collimator lens 202. The collimator lens 202 converts the red light beam Lr1 from a diverging light beam into a parallel light beam and causes the parallel light beam to enter a beam splitter 203. The beam splitter 203 has a wavelength selectivity (dichroic characteristic) that the reflectivity differs with the wavelength of a light beam, and reflects a light beam having a wavelength of approximately 650 [nm] at the ratio of approximately 100%, and also causes a light beam having a wavelength of approximately 405 [nm] to transmit therethrough at the ratio of approximately 100%. Thus, the red light beam Lr1 having a wavelength of approximately 650 [nm] is reflected at the ratio of approximately 100%, and is caused to enter the next beam splitter 204. The red light beam Lr1 transmitting through the beam splitter 204 is incident upon an objective lens 205. The objective lens 205 focuses the red light beam Lr1 to irradiate the reference layer RL of the optical disc 1 with the focused red light beam Lr1. At this time, the red light beam Lr1 is reflected in the reference layer RL of the optical disc 1, resulting in a red reflected light beam Lr2 traveling in a direction opposite to the red light beam Lr1.

The red reflected light beam Lr2 is converted into a parallel light beam by the objective lens 205 and is incident on the beam splitter 204. At this time, the red reflected light beam Lr2 is reflected by the beam splitter 204 and is incident upon a condensing lens 207. The condensing lens 207 focuses the red reflected light beam Lr2 to irradiate a photo detector 208 with the focused red light beam Lr2. A signal processing circuit 7 generates signals for servo control, such as a focus error signal and a tracking error signal, from the output of the photo detector 208. The signal processing circuit 7 also generates a rotation synchronization signal for controlling the rotation of the optical disc 1 and a signal for reproducing the address of a track, from the wobbled track formed in the reference layer RL. The signal processing circuit 7 further generates a signal for reproducing the disc-specific information, such as the intensity of a light beam for recording onto the recording layer WL, or the information for managing the user data recorded in the recording layer WL. The signal processing circuit 7 outputs these signals to a system controller 4. The system controller 4 outputs a focus control signal and a tracking control signal to an actuator driver 8 based on the focus error signal and the tracking error signal from the signal processing circuit 7. The objective lens 205 is configured so as to move integrally with an actuator 206. Here, the servo control is performed so that the red light beam Lr1 may follow a track while being focused on the reference layer RL by driving the actuator 206 in a focusing direction and a tracking direction according to the output of the actuator driver 10. Moreover, the system controller 4 outputs a spindle control signal to the spindle motor driver 11 based on the rotation synchronization signal output from the signal processing circuit 7. This control is performed so that the rotational speed of the disc 1 attached to the spindle motor 3 may be a predetermined one, by driving the spindle motor 3 using the output of the spindle motor driver 11.

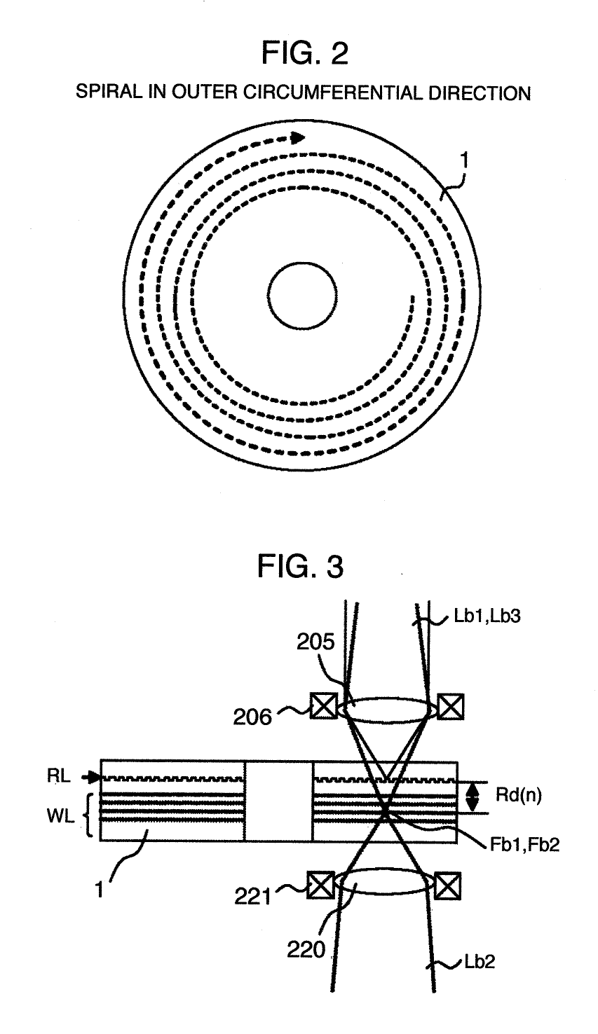

The track formed in the reference layer RL of the optical disc 1 is formed in a spiral shape as shown in FIG. 2, for example, wherein the tracking control is performed so that the red light beam Lr1 may follow the track of the reference layer, thereby allowing for continuous recording or reproduction from an inner periphery to an outer periphery of the disc 1. A detailed configuration of the reference layer RL is described later.

As described above, in the servo optical system of the optical pickup 2, the reference layer RL of the optical disc 1 is irradiated with the red light beam Lr1, and on the basis of the light reception result of the red reflected light beam Lr2 which is the reflected light of the red light beam Lr1, the focusing control and tracking control of the objective lens 205 are performed based on the control of the system controller 4 so as to cause the red light beam Lr1 to follow the track of the reference layer RL. Note that, taking into consideration an influence of a coma aberration due to a tilt of the optical disc 1 in performing recording or reproduction on the reference layer RL using the red light beam, the distance from the surface of the optical disc 1 on the red light beam incident side to the reference layer RL is preferably set to approximately 0.6 mm.

The information optical system emits blue light beams from mutually opposite directions to the optical disc 1 as the information recording medium so as to focus the both light beams onto an identical position within the recording layer WL.

In the information optical system, a laser 209 for recording/reproducing data is a semiconductor laser emitting a blue laser light having a wavelength of approximately 405 [nm], for example, and emits a blue light beam Lb0 with a predetermined light quantity based on the control of the laser driver 6 and causes the same to enter a collimator lens 210. The collimator lens 210 converts the blue light beam Lb0 from a diverging light beam into a parallel light beam and causes the parallel light beam to enter a beam splitter 211. The beam splitter 211 is adapted to transmit the light beam therethrough at the ratio of approximately 50% and reflect the remaining approximately 50%. Thus, approximately 50% of the blue light beam Lb0 transmitting through the beam splitter 211 is referred to as a blue light beam Lb1 and the remaining approximately 50% of the blue light beam Lb0 reflected by the beam splitter 211 is referred to as a blue light beam Lb2. After being reflected by a mirror 212, the blue light beam Lb1 is incident upon a beam splitter 213. The beam splitter 213 transmits the blue light beam Lb1 therethrough at a predetermined ratio and causes the same to enter a relay lens 214. The relay lens 214 converts the blue light beam Lb1 from the parallel light beam into a focused light beam or a diverging light beam by a movable lens 214A, and furthermore changes the focusing state of the blue light beam Lb1 by a fixed lens 214B and causes the resulting blue light beam Lb1 to enter the beam splitter 203.

Here, the movable lens 214A is adapted to move in the optical axis direction of the blue light beam Lb1 by a non-illustrated actuator, and the focusing state of the blue light beam Lb1 emitted from the fixed lens 214B is changed by moving the movable lens 214A based on the output of a relay lens driver 9.

The beam splitter 203 transmits the blue light beam Lb1 therethrough depending on its wavelength and causes the resulting blue light beam Lb1 to enter the beam splitter 204. The beam splitter 204 transmits the blue light beam Lb1 therethrough at a predetermined ratio and causes the same to enter the objective lens 205. The objective lens 205 focuses the blue light beam Lb1, and causes the focused blue light beam Lb1 to transmit through the reference layer RL of the optical disc 1 and focus within the recording layer WL. Here, the position of a blue light focal point Fb1 of the blue light beam Lb1 is determined by the focusing state when emitted from the fixed lens 214B of the relay lens 214. That is, the blue light focal point Fb1 will move in the focusing direction within the recording layer WL according to the position of the movable lens 214A. Thus, the blue light beam Lb1 is emitted from the reference layer RL side of the optical disc 1 and the focal point Fb1 is caused to be positioned within the recording layer WL, and furthermore, a depth Rd from the reference layer RL of the focal point Fb1 is adapted to be adjusted according to the position of the movable lens 214A in the relay lens 214. The movement distance of the movable lens 214A is designed so as to be substantially proportional to the movement distance of the blue light focal point Fb1 of the blue light beam Lb1, and for example, if the movable lens 214A is moved by 1 [nm], the blue light focal point Fb1 of the blue light beam Lb1 will move by 30 [nm].

On the other hand, the blue light beam Lb2 reflected in the beam splitter 211 is incident upon a shutter 222. The shutter 222 is driven by the output of a shutter driver 12 according to an instruction from the system controller 4, wherein during recording, the shutter 22 is opened to transmit therethrough the blue light beam Lb2 incident from the beam splitter 211, while during reproduction, the shutter 22 is closed to block the blue light beam Lb2 incident from the beam splitter 211. The blue light beam Lb2 transmitting through the shutter 222 is sequentially reflected in mirrors 217 and 218, and is then incident upon a relay lens 219. The relay lens 219 is configured as with the relay lens 214, and comprises a movable lens 219A and a fixed lens 219B corresponding to the movable lens 214A and the fixed lens 214B, respectively. The relay lens 219 converts the blue light beam Lb2 from the parallel light beam to a focused light or a diverging light beam by the movable lens 219A, and furthermore changes the focusing state of the blue light beam Lb2 by the fixed lens 219B and causes the resulting blue light beam Lb2 to enter the objective lens 220. Moreover, the relay lens 219, as with the relay lens 214, moves the movable lens 219A by an actuator (not shown) based on the output of the relay lens driver 9 so that the focusing state of the blue light beam Lb2 emitted from the fixed lens 219B may be changed.

The objective lens 220 has the same optical property as the objective lens 205, and focuses the blue light beam Lb2 to irradiate the recording layer WL of the optical disc 1 with the focused blue light beam Lb2. Here, the position of a blue light focal point Fb2 of the blue light beam Lb2 is determined by the focusing state when emitted from the fixed lens 219B of the relay lens 219. That is, the blue light focal point Fb2 will move in the focusing direction within the recording layer WL according to the position of the movable lens 219A. Thus, the blue light beam Lb2 is emitted from the recording layer WL side of the optical disc 1 and the focal point Fb2 is caused to be positioned within the recording layer WL, and furthermore, a depth Rd2 from the reference layer RL of the focal point Fb2 is adapted to be adjusted according to the position of the movable lens 2194A in the relay lens 219. The movement distance of the movable lens 219A is designed so as to be substantially proportional to the movement distance of the blue light focal point Fb2 of the blue light beam Lb2, and for example, if the movable lens 219A is moved by 1 [nm], the blue light focal point Fb2 of the blue light beam Lb2 will move by 30 [nm].

The blue light beam Lb2 converges at the focal point Fb2 once, and further travels while diverging. Hereinafter, this light beam is referred to as a blue transmitted light beam Lb3. After the angle of divergence is adjusted by being incident upon the objective lens 205, the blue transmitted light beam Lb3 is sequentially through the beam splitter 204, the beam splitter 203, and the relay lens 214 so as to follow in the opposite direction of the optical path of the blue light beam Lb1 and is then incident upon the beam splitter 213.

The beam splitter 213 reflects the blue transmitted light beam Lb3 at a predetermined ratio, and focuses the resulting blue transmitted light beam Lb3 by the condensing lens 215 to irradiate the photo detector 216. The photo detector 216 detects a part of the blue transmitted light beam Lb3, and outputs a detection signal corresponding to a light quantity detected at this time to the signal processing circuit 8.

The signal processing circuit 8 generates a focus error signal indicative of a deviation amount in the focusing direction between the focal point Fb1 of the blue light beam Lb1 and the focal point Fb2 of the blue light beam Lb2, and a tracking error signal indicative of the deviation amount in the track direction, and outputs these signals to the system controller 4.

The system controller 4 outputs a focus control signal and a tracking control signal to the actuator driver 10 based on the focus error signal and the tracking error signal from the signal processing circuit 8. The objective lens 220 is configured so as to move integrally with an actuator 221, and the servo control is performed so that the focal point Fb2 of the blue light beam Lb2 may be coincident with the focal point Fb1 of the blue light beam Lb1 and so that the focal point Fb2 of the blue light beam Lb2 may follow the focal point Fb1 of the blue light beam Lb1, by driving the actuator 221 in the focusing direction and the tracking direction according to the output of the actuator driver 10. Thus, as shown in FIG. 3, the blue light beam Lb2 and the blue light beam Lb1 are positioned in a focus position in the recording layer WL of the same depth Rd (n) corresponding to the n-th layer from the reference layer RL and interfere with each other, thereby forming a microholography and performing recording.

Next, the reproduction operation is described. In reproduction, as in the case of recording, with the use of the servo optical system, the reference layer RL of the optical disc 1 is irradiated with the red light beam Lr1, and on the basis of the light reception result of the red reflected light beam Lr2 which is the reflected light of the red light beam Lr1, the focusing control and tracking control of the objective lens 205 are performed based on the control of the system controller 4 so as to cause the red light beam Lr1 to follow the track of the reference layer RL.

On the other hand, in the information optical system, as in the case of recording, the laser 209 emits the blue light beam Lb0 with a predetermined light quantity corresponding to the reproduction based on the control of the laser driver 6 and causes the same to enter the collimator lens 210. The collimator lens 210 converts the blue light beam Lb0 from a diverging light beam into a parallel light beam and causes the parallel light beam to enter the beam splitter 211. As in the case of recording, the blue light beam Lb2 reflected by the beam splitter 211 is incident upon the shutter 222. The shutter 222, during reproduction, is closed by the output of the shutter driver 12 according to an instruction from the system controller 4, so that the blue light beam Lb2 is blocked. Thus, during reproduction, the optical disc 1 will be irradiated with only the blue light beam Lb1 transmitting through the beam splitter 211.

The blue light beam Lb1 transmitting through the beam splitter 211 is incident upon the relay lens 214 through the mirror 212 and the beam splitter 213. The relay lens 214 changes the focusing state of the blue light beam Lb1 and causes the resulting blue light beam Lb1 to enter the beam splitter 203.

The beam splitter 203 transmits the blue light beam Lb1 therethrough depending on its wavelength and causes the resulting blue light beam Lb1 to enter the beam splitter 204. The beam splitter 204 transmits the blue light beam Lb1 therethrough at a predetermined ratio and causes the same to enter the objective lens 205. The objective lens 205 focuses the blue light beam Lb1, and causes the focused blue light beam Lb1 to transmit through the reference layer RL of the optical disc 1 and focus within the recording layer WL. Here, the position of the blue light focal point Fb1 of the blue light beam Lb1 is determined by the focusing state in being emitted from the fixed lens 214B of the relay lens 214, and the blue light beam Lb1 can be focused as a holography on any layer of a plurality of layers formed within the recording layer WL. The light beam reflected by the holography serves as a blue reflected light beam Fb1r, which then follows in the opposite direction of the optical path of the blue light beam Lb1 and is through the objective lens 205, the beam splitter 204, the beam splitter 203, and the relay lens 214 and is then incident upon the beam splitter 213. The beam splitter 213 reflects the blue transmitted light beam Lb1r at a predetermined ratio, and focuses the resulting blue transmitted light beam Lb1r by the condensing lens 215 to irradiate the photo detector 216. The photo detector 216 outputs a detection signal corresponding to the detected light quantity to the signal processing circuit 8. The signal processing circuit 8 generates a reproduced signal corresponding to the holography formed in the optical disc 1 and outputs the same to the system controller 4. The system controller 4 reproduces the data recorded in the optical disc by performing processing, such as decoding, based on the reproduced signal.

The optical disc apparatus in this embodiment will be described as performing both the above-described recording operation and reproducing operation, however, of course, the present invention is not limited thereto. For example, an optical disc apparatus performing only the above-described reproducing operation is included in the present invention.

Hereinafter, particularly characteristic configurations in the optical disc and recording/reproducing operation of this embodiment will be described in detail.

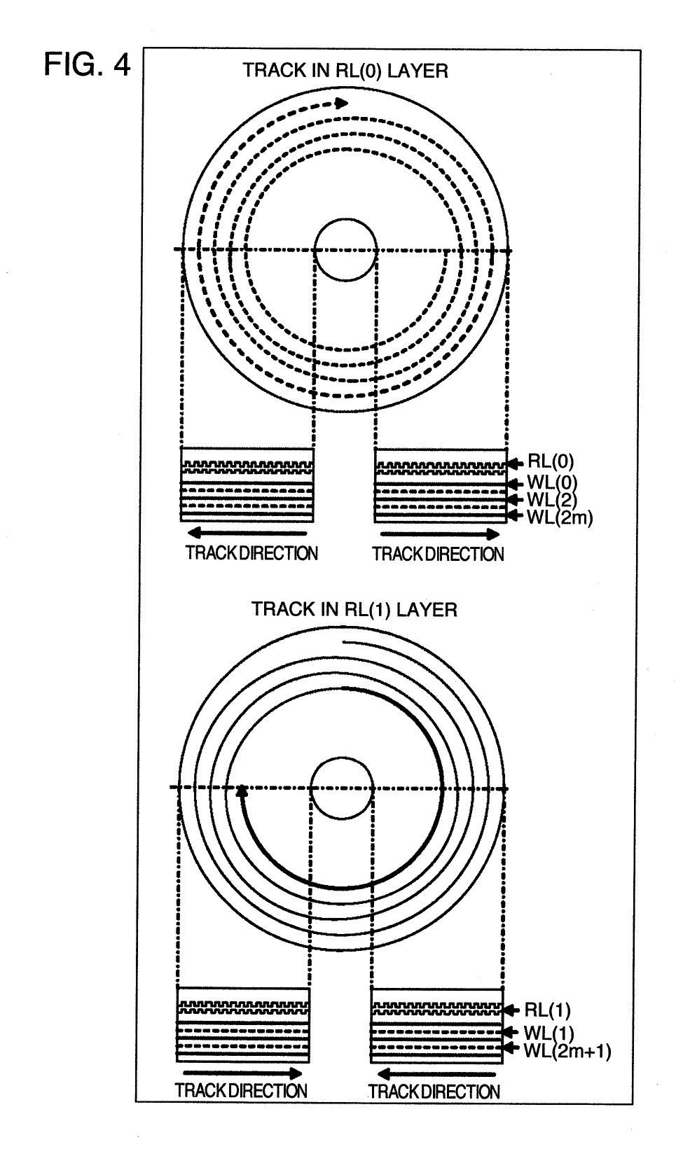

FIG. 4 is a schematic view showing a detailed configuration of the optical disc 1 in this embodiment. As shown in FIG. 4, the reference layer RL comprises two reference layers. That is, RL(0) and RL(1) respectively are reference layers, and the direction of the spiral direction of the track of each layer is opposite.

Moreover, WL(n) is the n-th recording layer from the reference layer side, and in WL(2m), i.e., the even-numbered layer, data is recorded in the same spiral direction as the reference layer RL(0), while in WL(2m+1), i.e., the odd-numbered layer, data is recorded in the same spiral direction as the reference layer RL(1).

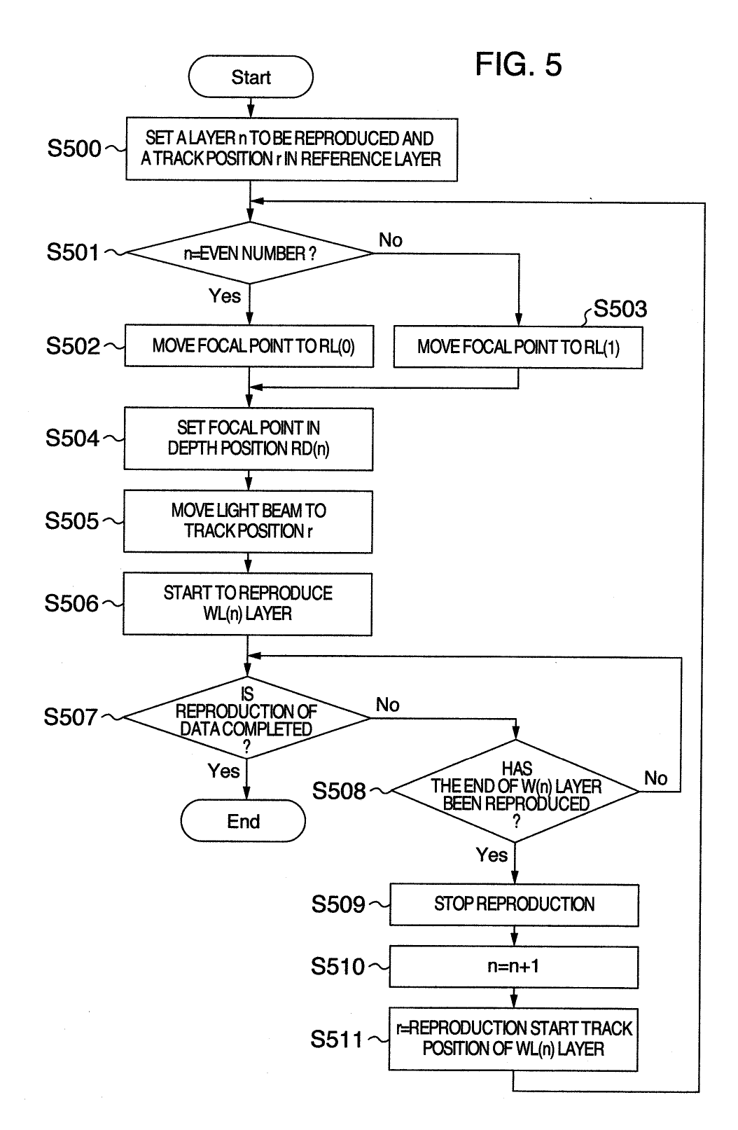

Next, the processing for reproducing the optical disc of FIG. 4 is described in detail using a flowchart of FIG. 5.

First, a layer n to be reproduced in the recording layer WL and a track position r in the reference layer RL corresponding to a reproduction start radial position of the recording layer WL are set (S500). Next, it is determined whether the layer n to be reproduced is an even layer or an odd layer (S501). If it is an even layer, the focus position of the red light beam Lr1 is moved to the reference layer RL(0) (S502). If it is an odd layer, the focus position of the red light beam Lr1 is moved to the reference layer RL(1) (S503). Next, the position of the movable lens 214A in the relay lens 214 is moved so that the focal point Fb1 of the blue light beam may be set at a depth Rd(n) of the reproducing layer (S504). The red light beam Lr1 is moved to the track position r of the reference layer RL based on an address of the track formed in the reference layer RL (S505). This causes the position in the focusing direction and the tracking direction of the blue light focal point Fb1 to be coincident with the position of a holography to be reproduced, and the user data recorded in the n-th layer of the recording layer WL is started to be reproduced (S506). In Step S507, it is determined whether all the requested data have been reproduced, and if all the data have been reproduced (Yes), then the processing is completed. If all the data have not been reproduced yet (No), then it is determined, from the address information of the track reproduced from the reference layer RL, whether the end of the layer currently being reproduced has been reproduced (S508). If the end of the layer currently being reproduced has not been reproduced yet (No), the flow returns to the processing in Step S507, and the reproduction of data is continued. If the end of the layer currently being reproduced has been reproduced (Yes), the reproduction is stopped once (S509), and the layer n to be reproduced is changed to the layer n+1 to be reproduced (S510), and the track position r in the reference layer RL corresponding to the reproduction start radial position of the n-th layer of the recording layer WL is set (S511). Here, in an even layer the reproduction start radial position of the n-th layer of the recording layer WL is arranged in an inner periphery while in an odd layer it is arranged in an outer periphery. The layer n to be recorded and the track position r are updated, and the flow returns to Step S501. The number of the layer to be reproduced varies from an odd number to an even number or vice versa in Step S510, and therefore in Step 501 the flow branches to a processing different from the previous one and the focus position will be moved to the different reference layer RL. Hereinafter, the layer n to be recorded and the track position r are updated, and the focus position of the red light beam Lr1 is moved alternately to the reference layer RL(0) or RL(1), and the processings from Step S501 and thereafter will be repeated until all the requested data are reproduced while changing the depth Rd (n) of a layer to be reproduced by the blue light focal point Fb1.

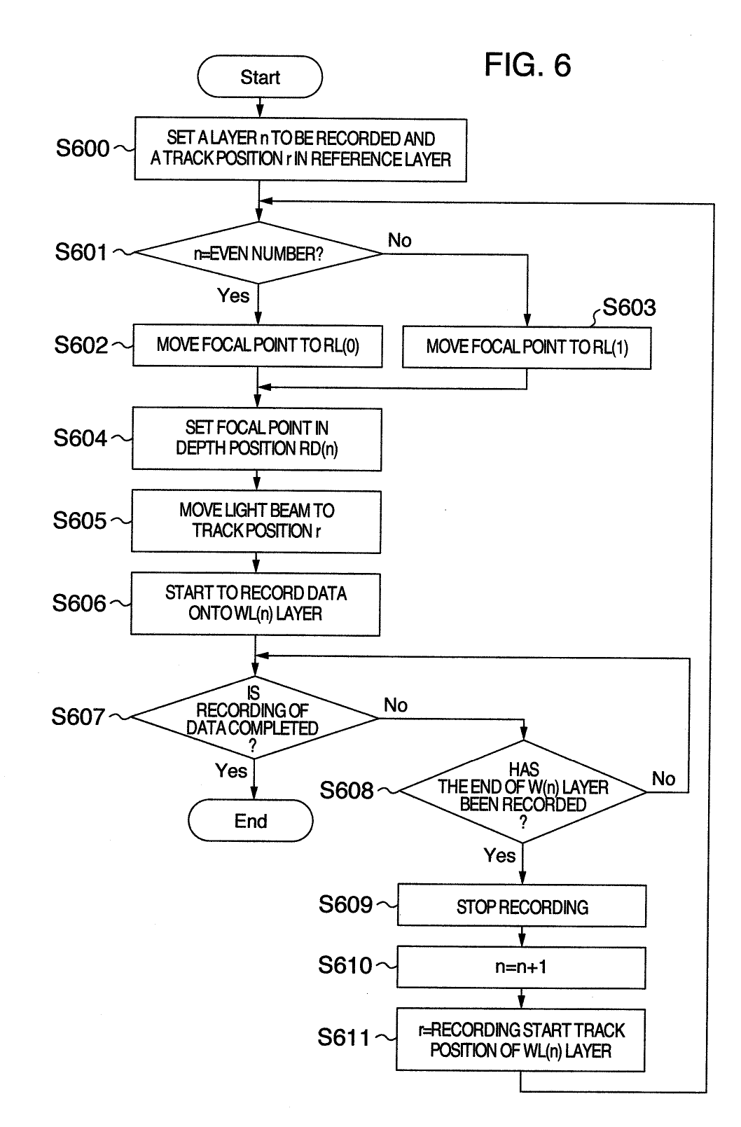

Next, the processing for perform recording on the optical disc of FIG. 4 is described in detail using a flowchart of FIG. 6.

First, the layer n to be recorded in the recording layer WL and the track position r in the reference layer RL corresponding to the recording start radial position of the recording layer WL are set (S600). Next, it is determined whether the layer n to be recorded is an even layer or an odd layer (S601). If it is an even layer, the focus position of the red light beam Lr1 is moved to the reference layer RL(0) (S602). If it is an odd layer, the focus position of the red light beam Lr1 is moved to the reference layer RL(1) (S603). Next, the position of the movable lens 214A in the relay lens 214 and the position of the movable lens 219A in the relay lens 219 are moved so that the blue light focal points Fb1 and Fb2 may be set at the depth Rd (n) of the recording layer (S605). The red light beam Lr1 is moved to the track position r of the reference layer RL based on the address of the track formed in the reference layer RL (S605). This causes the position in the focusing direction and the tracking direction of the blue light focal points Fb1 and Fb2 to be coincident with the recording position, and the user data is started to be recorded onto the n-th layer of the recording layer WL (S606). In Step S607, it is determined whether all the requested data have been recorded, and if all the data have been recorded (Yes), then the processing is completed. If all the data have not been recorded yet (No), then it is determined, from the address information of the track reproduced from the reference layer RL, whether the end of the layer currently being recorded has been recorded (S608). If the end of the layer currently being recorded has not been recorded yet (No), the flow returns to the processing in Step S607, and the recording of data is continued. If the end of the layer currently being recorded has been recorded (Yes), then the recording is stopped once (S609) and the layer n to be recorded is changed to the layer n+1 to be recorded (S610), and the track position r in the reference layer RL corresponding to the recording start radial position of the n-th layer of the recording layer WL is set (S611). Here, in an even layer, the recording start radial position of the n-th layer of the recording layer WL is arranged in an inner periphery while in an odd layer it is arranged in an outer periphery. The layer n to be recorded and the track position r are updated, and the flow returns to Step S601. The number of a layer to be recorded varies from an odd number to an even number or vice versa in Step S610, and therefore in Step 601 the flow branches to a processing different from the previous one and the focus position will be moved to the different reference layer RL. Hereafter, the layer n to be recorded and the track position r are updated, and the focus position of the red light beam Lr1 is moved alternately to the reference layer RL(0) or RL(1), and the processings from Step S601 and thereafter will be repeated until all the requested data are recorded while changing the depth Rd (n) of a layer to be recorded by the blue light focal point Fb1.

In the above embodiment, the processing (S604) for setting the depth of the blue light focal point comes after the processings (from S601 to S603) for moving the focus position of the red light beam Lr1, however, the order of the processings may be changed or these processings may be performed simultaneously.

In the above embodiment, because the recording is performed by moving the focus position of the red light beam Lr1 alternately to either of two reference layers RL(0) and RL(1) having the spiral directions of the track different from each layer, the data recorded in the recording layer WL is also recorded with the spiral direction alternately different for each layer. For example, in recording information with the blue light focal point Fb focused on a predetermined depth position of the recording layer WL, the red light beam Lr1 is focused on the track of a reference layer having a corresponding spiral direction, of two reference layers RL(0) and RL(1), so that the spiral direction may differ from the adjacent recording surface in the depth direction of the recording layer WL.

In other words, this embodiment is characterized in that when information is recorded with the blue light focus point Fb focused in a first depth position of the recording layer WL and thereafter the blue light focus point Fb is switched to a second depth position different from the first depth position, the focusing position of the red light beam Lr1 is controlled so as to move from the reference layer RL(0) to the other reference layer RL(1) having the different spiral direction.

Thus, the recording start track position r of a layer to be recorded next can be set to substantially the same radial position even if the recording layer has been changed in the middle of recording user data, and therefore the track movement processing can be performed in a short time, the recording stop time due to the layer switching can be reduced, and the recording time can be reduced. Moreover, also in performing reproduction of the recorded user data, the track movement when a layer to be reproduced has been changed can be performed in a short time, and the reproduction stop time due to the layer switching can be reduced and the reproduction time can be reduced. That is, a radial position where the recording or reproduction of one layer is completed and a radial position where the recording or reproduction is started in the next layer become substantially the same, and the time required to move the light beam in the radial direction of the disc in switching layers can be reduced. Thus, the time to interrupt recording or reproduction can be reduced.

Furthermore, if the position of the blue light focus point Fb is controlled so as to switch to the second depth position of the recording layer WL after moving the focusing position of the red light beam Lr1, for example, from the reference layer RL(0) to the other reference layer RL(1) having the different spiral direction, then the position of the blue light focus point Fb moves to a target layer (or target depth position) of the recording layer WL with the address information of the reference layer RL being detected. It is therefore possible to confirm that the blue light focus point Fb has reached the target layer. Thus, the movement processing of the blue light focus point Fb in switching layers can be stably performed.

Note that, taking into consideration an influence of a coma aberration due to a tilt of the optical disc 1 in performing recording or reproduction on the reference layer RL using the red light beam and an influence of a spherical aberration due to a difference between the distance from the surface of the optical disc 1 to the reference layers RL(0) and the distance from the surface of the optical disc 1 to the reference layer RL(1), preferably, the distance from the surface of the optical disc 1 on the red light beam incident side to the reference layer RL(0) is approximately 0.6 mm and the distance between the reference layers RL(0) and RL(1) is approximately 60 μm±10 μm.

In the above embodiment, for the recording layer, the recording is performed by microholography, however, the present invention is not limited thereto as long as an optical disc or an optical disc recording/reproducing apparatus is capable of performing recording or reproduction on a recording layer by changing the depth position while following the track of a reference layer. The present invention may be applicable to, for example, an optical disc apparatus and an optical disc capable of performing recording or reproduction on a recording layer using a two-photon absorption compound in a predetermined depth position by changing the depth position from a reference layer.

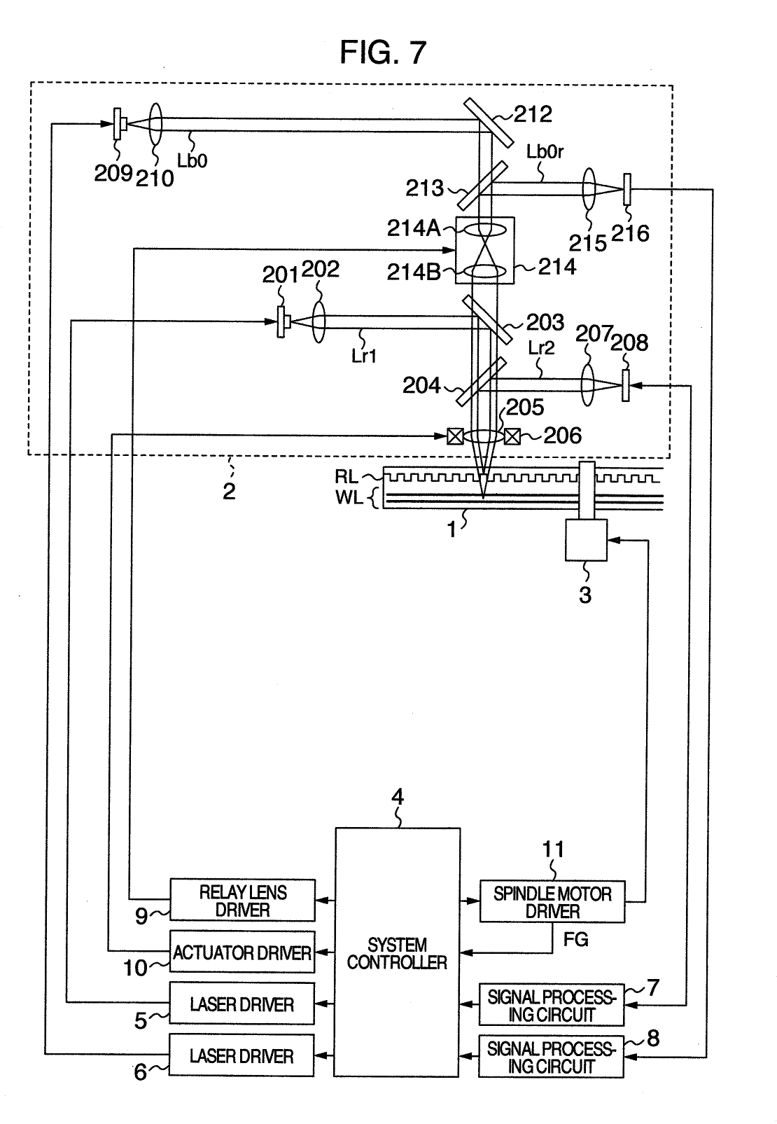

FIG. 7 is a block diagram showing a configuration of an optical disc recording/reproducing apparatus performing recording/reproduction on an optical disc with a recording layer using a two-photon absorption compound, wherein the same number is attached to a block having the same function as FIG. 1, and the description thereof is omitted. In an optical disc for performing recording/reproduction by two-photon absorption, there is no need to branch a blue light beam from the laser 209 of an information optical system into two light beams to interfere with each other, unlike the recording/reproduction by holography. For this reason, the configuration can be made simpler than the optical disc apparatus performing recording/reproduction by holography of FIG. 1.

The optical pickup 2 comprises: a servo optical system for performing servo control on the reference layer RL, reproducing the address of a track and the disc-specific information from a wobbled track, recording/reproducing the information and the like for managing the data to be recorded on the recording layer; and an information optical system for recording/reproducing data in a plurality of depth positions at different distances from the reference layer RL.

In the servo optical system of the optical pickup 2, the reference layer RL of the optical disc 1 is irradiated with the red light beam Lr1, and on the basis of a light reception result of the red reflected light beam Lr2 which is the reflected light of the red light beam Lr1, the focusing control and tracking control of the objective lens 205 are performed based on the control of the system controller 4 so as to cause the red light beam Lr1 to follow the track of the reference layer RL. Note that, taking into consideration an influence of a coma aberration due to a tilt of the optical disc 1 in performing recording or reproduction on the reference layer RL using the red light beam, the distance from the surface of the optical disc 1 on the red light beam incident side to the reference layer RL is preferably set to approximately 0.6 mm.

The information optical system is adapted to emit the blue light beam Lb0 from the reference layer RL side to the optical disc 1 as an information recording medium and position the focal point Fb1 within the recording layer WL, and furthermore adjust the depth Rd from the reference layer RL of the focal point Fb1 according to the position of the movable lens 214A in the relay lens 214.

The recording layer WL contains a two-photon absorbing material for absorbing two photons of a light beam having a wavelength of 405 [nm]. It is known that this two-photon absorbing material causes two-photon absorption in proportion to the square of light intensity, and causes two-photon absorption only with respect to the light with a very large light intensity.

In recording information on the recording layer WL, the blue light beam Lb0 with a relatively high intensity is emitted to evaporate the two-photon absorbing material by two-photon absorption and form an air bubble at the focal point Fb1 within the recording layer WL, thereby recording. The air bubble formed in this manner is arranged in a planar manner substantially parallel to the servo layer RL of the optical disc 1. A plurality of recording layers can be formed by changing the depth Rd from the reference layer RL of the focal point Fb1 according to the position of the movable lens 214A in the relay lens 214.

On the other hand, in reproducing information from the recording layer WL, a constant weak blue light beam Lb0 not causing two-photon absorption is emitted and focused on an arbitrary layer, in which an air bubble is formed by two-photon absorption, within the recording layer WL by changing the depth Rd from the reference layer RL of the focal point Fb1 according to the position of the movable lens 214A in the relay lens 214, and furthermore its reflected light Lb0r is received by the photo detector 216, so that the arbitrary layer can be reproduced.

### Embodiment 2

Next, a second embodiment of the present invention is described.

Since the configuration of an optical disc apparatus in this embodiment is the same as that of Embodiment 1, the description thereof is omitted.

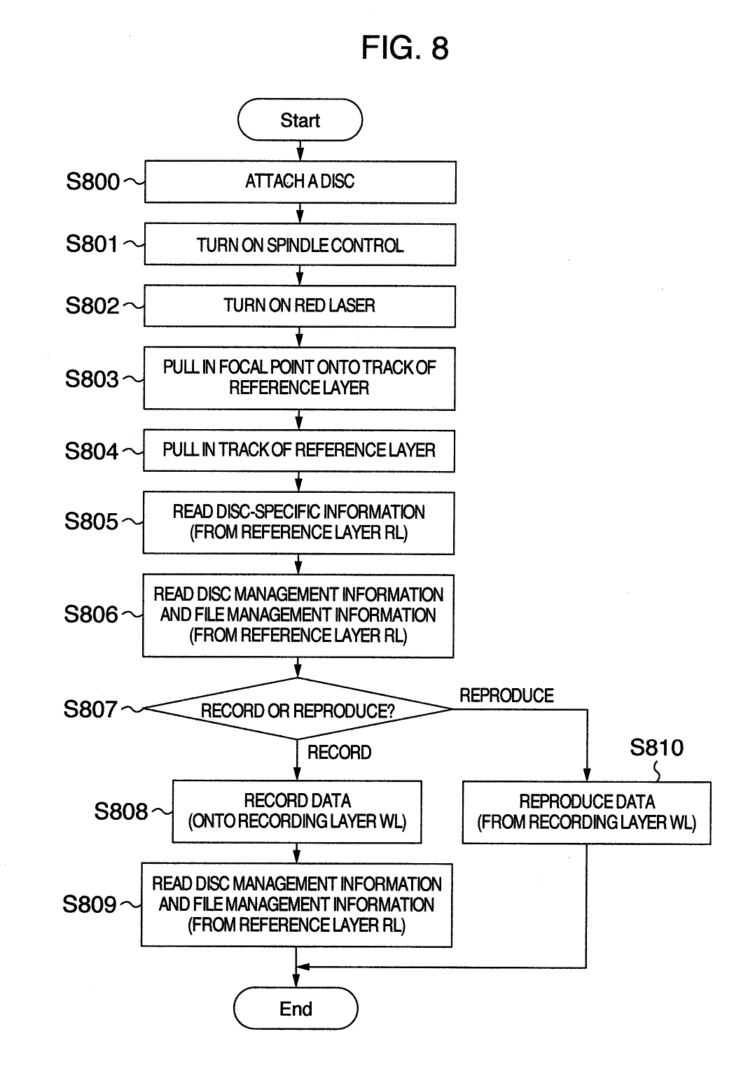

A recording/reproduction procedure of the optical disc apparatus of this embodiment is described using a flowchart of FIG. 8.

First, upon detection of the optical disc 1 being attached to the spindle motor 3 (S800), the spindle control is turned on. An FG signal of a frequency corresponding to the rotational speed of the spindle motor 3 is output from the spindle motor driver 11, and based on this, the optical disc 1 is rotated at a predetermined rotation frequency (S801). Next, the laser 201 of the servo optical system is turned on (S802) to start focus control so as to pull in the focus and so that the red light beam Lr1 may be focused on the reference layer RL (S803). The red light beam Lr1 is focused on the reference layer RL, so that a tracking error signal indicative of a positional deviation between the track provided in the reference layer RL and the red light beam Lr1 is detected. The track is pulled in based on this tracking error signal, and the tracking control is started so that the red light beam Lr1 may follow the track of the reference layer RL (S804). The red light beam Lr1 follows the track of the reference layer RL, so that a signal for reproducing a rotation synchronization signal for controlling the rotation of the disc and the address of the track is detected from the wobbled track formed in the reference layer RL. Based on the detected rotation synchronization signal, spindle control is performed and the address of the track being irradiated with the red light beam Lr1 is reproduced. Based on this address, the red light beam Lr1 is moved to a track in a predetermined radial position of the reference layer RL, and the disc-specific information recorded in advance as a wobbled track is read (S805). Next, file management information for managing disc management information and user data including information on the position of a defect portion of the recording layer WL and the like is read from a recordable/reproducible track of the reference layer RL (S806). The examples of the disc management information include: information on an additionally recordable capacity in a recording layer; information on the final recording position on a recording layer, such as the number of a layer in which user data was lastly recorded (that is, the depth Rd from the reference layer RL of the blue light focus point Fb at which recording was lastly performed), and the address of a track; an address at which a defect has been detected; an address of a replaced destination; and the like. The examples of the file management information include the number of a layer in which a file is recorded, the address of a track, the capacity of the file, the name of the file, and the like. In Step S807, branching is performed depending on whether to record user data or to reproduce user data, and if recording is performed, data is recorded on the recording layer WL by causing the laser 209 of the information optical system to emit light according to the output of the laser driver 6 (S808). After recording data, the disc management information and file management information are recorded on a recordable/reproducible track of the reference layer RL (S809), and then the recording is completed. If the flow branched to the reproduction processing in Step S807, the data is reproduced from the recording layer WL by causing the laser 209 of the information optical system to emit light with a predetermined light quantity according to the output of the laser driver 6 (S810).

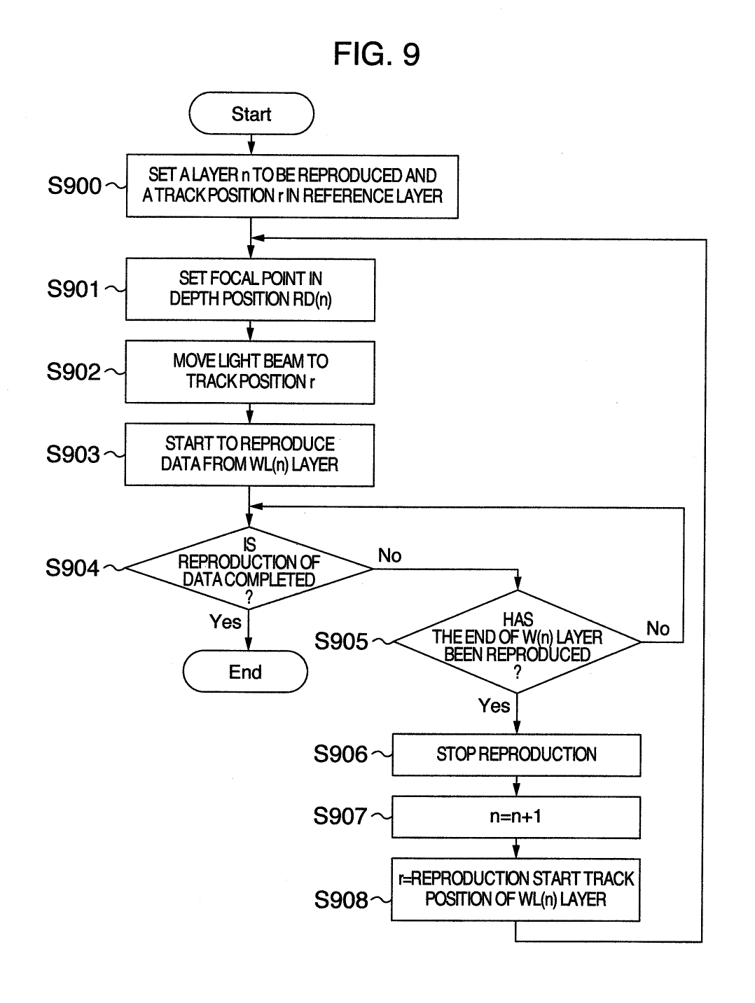

Next, the reproduction processing of Step 810 is described in detail using a flowchart of FIG. 9.

Based on the disc management information and file management information obtained in Step S806, the layer n to be reproduced in the recording layer WL and the track position r in the reference layer RL corresponding to a reproduction start radial position of the recording layer WL are set (S900). Next, the position of the movable lens 214A in the relay lens 214 is moved so that the focal point Fb may be set at the depth Rd(n) corresponding to the layer n to be reproduced (S901). The red light beam Lr1 is moved to the track position r of the reference layer RL based on the address of the track formed in the reference layer RL (S902). This causes the position in the focusing direction and the tracking direction of the blue light focus point Fb1 to be coincident with the position of a holography to be reproduces, and the user data recorded in the n-th layer of the recording layer WL is started to be reproduced (S903). In Step S904, it is determined whether all the requested data have been reproduced, and if all the data have been reproduced (Yes), then the processing is completed. If all the data have not been reproduced yet (No), then it is determined, from the address information of a track reproduced from the reference layer RL, whether the end of the layer currently being reproduced has been reproduced (S905). If the end of the layer currently being reproduced has not been reproduced yet (No), the flow returns to the processing in Step S904, and the reproduction of data is continued. If the end of the layer currently being reproduced has been reproduced (Yes), the reproduction is stopped once (S906), and the layer n to be reproduced is changed to the layer n+1 to be reproduced (S907), and the track position r in the reference layer corresponding to the reproduction start radial position of the n-th layer of the recording layer WL is set (S908). The layer n to be reproduced and the track position r are updated, and the processings from Step S901 and thereafter will be repeated until all the requested data are reproduced.

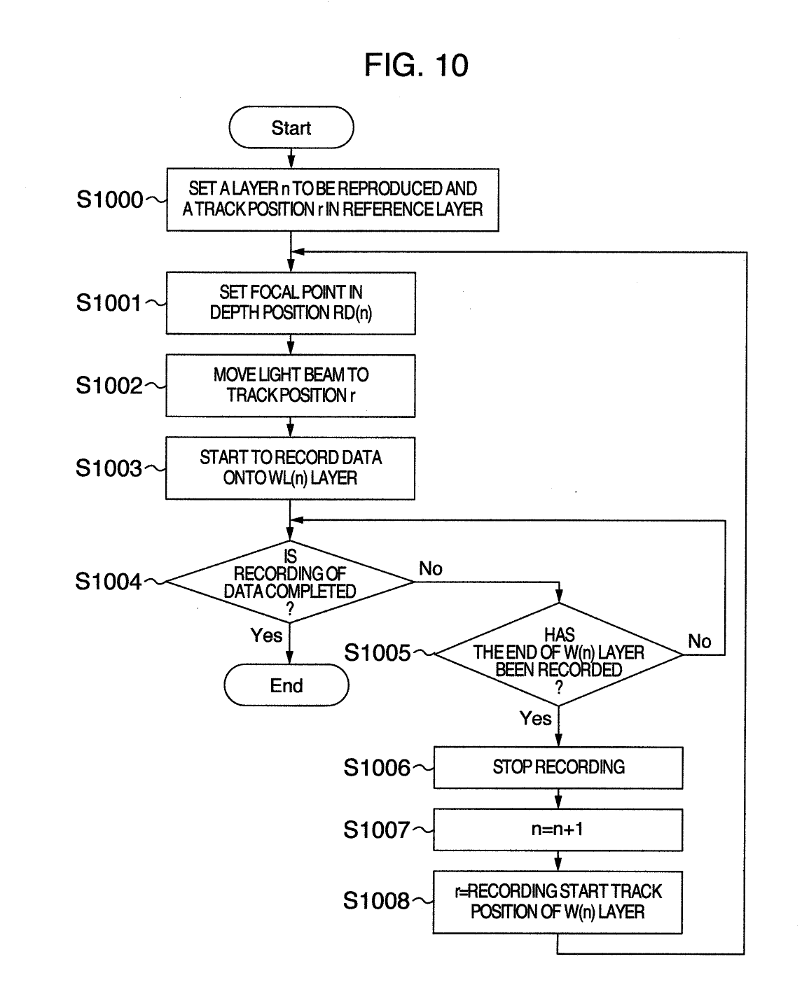

Next, the recording process (Step S808) of FIG. 8 is described in detail using a flowchart of FIG. 10.

Based on the disc management information and file management information, the layer n to be recorded in the recording layer WL and the track position r in the reference layer RL corresponding to the recording start radial position of the recording layer WL are set (S1000). Next, the position of the movable lens 214A in the relay lens 214 and the position of the movable lens 219A in the relay lens 219 are moved so that the blue light focal point Fb may be set at the depth Rd (n) corresponding to the layer n to be recorded (S1001). The red light beam Lr1 is moved to the track position r of the reference layer RL based on the address of the track formed in the reference layer RL (S1002). Thus, the position in the focusing direction and the tracking direction of the blue light focal point Fb is set, and the user data is started to be recorded onto the n-th layer of the recording layer WL (S1003). In Step S1004, it is determined whether all the requested data have been recorded, and if all the data have been recorded (Yes), then the processing is completed. If all the data have not been recorded yet (No), then it is determined, from the address information of a track reproduced from the reference layer RL, whether the end of the layer currently being recorded has been recorded (S1005). If the end of the layer currently being recorded has not been recorded yet (No), the flow returns to the processing in Step S1004, and the recording of data is continued. If the end of the layer currently being recorded has been recorded (Yes), then the recording is stopped once (S1006) and the layer n to be recorded is changed to the layer n+1 to be recorded (S1007), and the track position r in the reference layer RL corresponding to the recording start radial position of the n-th layer of the recording layer WL is set (S1008). While updating the layer n to be recorded and the track position r, the processings from Step S1001 and thereafter will be repeated until all the requested data are recorded.

In reproducing the information recorded by the micro-reflector, the light beam needs to be focused in the depth position where the information was recorded. Although the depth position at which the light beam is focused is determined by the position of the relay lens, the relationship between the depth position and the position of the relay lens will vary if an apparatus which performed recording differs from an apparatus which performs reproduction, or it will vary with a change in the environmental temperature, or the like. For this reason, an adjustment operation is required in order to focus the light beam onto a desired depth position. Accordingly, in starting reproduction of a disc, it takes time to read the disc management information including the positional information on a defect portion of a disc recorded by the micro-reflector or file management information, such as the file name of user data, and the capacity of the file. Therefore, it takes time to recognize the predetermined management information, for example, such as the additionally recordable capacity of the disc, the final recording position, what kind of user data is recorded, which are modified each time data is recorded onto a recording layer, thus posing a problem of poor usability.

In this embodiment, the disc-specific information, particularly, predetermined management information, which is modified each time the information is recorded onto the recording layer WL, is formed in the reference layer RL in advance as a wobbled track, and therefore the disc can be prepared more easily than the case of recording the disc-specific information as a holography onto the recording layer WL. Moreover, the disc-specific information can be easily obtained by irradiating the reference layer with a red light beam. Furthermore, a recordable and reproducible track is provided in the reference layer RL, and as the disc management information and file management information, particularly the predetermined management information, which is modified each time information is recorded onto the recording layer WL, is recorded/reproduced to/from this track, so that the information, such as the layer n, to/from which the user data is recorded/reproduced, in the recording layer WL, the track position r, and the like, are obtained. Therefore, the position in the focusing direction and tracking direction of the blue light focus point Fb can be promptly caused to be coincident with the position at which recording or reproduction is started, and the recording or reproduction can be started. In this way, the disc management information or file management information recorded in the reference layer is read in starting reproduction of the disc, so that the additionally recordable capacity of the disc or what kind of user data is recorded can be known in a short time, thus improving the usability.

Moreover, the management information recorded in the reference layer may be information indicative of the spiral direction of the recording surface formed in a predetermined depth position of the recording layer WL in the above-described Embodiment 1. That is, for example, the information on the depth position of the n-th recording layer W(n) in the recording layer WL or the number n of a layer, and whether the reference layer corresponding to this recording layer W(n) is the reference layer RL(0) or the reference layer RL(1) having the spiral direction opposite thereto are stored in the reference layer as the management information. This makes it possible to reliably perform the control in switching layers in the recording/reproducing operation of Embodiment 1. For example, in reproducing the predetermined recording layer W(n), which the focusing position of the red light beam Lr1 is set to, the reference layer RL(0) or the reference layer RL(1), can be reliably detected and a stable reproducing operation can be achieved.

Of course, the method of detecting the reference layer RL corresponding to the predetermined recording layer W(n) is not limited thereto, and if a method of alternately forming a spiral as described in Embodiment 1 is used, a corresponding reference layer can be reliably determined by detecting whether the number of a layer n of the predetermined recording layer W(n) is an even number or an odd number.

In the foregoing, the present invention has been described with reference to the embodiments, however, the present invention is not to be construed as being limitations on the above-described embodiments, and of course, modifications and improvements may be optionally made. For example, in the first and second embodiments, the reference layer may be just once-writable or may be once-writable and rewritable. Although the track of FIG. 2 is assumed to be spiral in the outer circumferential direction, it may be spiral in the inner circumferential direction. Similarly, in FIG. 4, the track of RL(0) is assumed to be spiral in the outer circumferential direction and the track of RL(1) is assumed to be spiral in the inner circumferential direction, however, the track of RL(0) may be spiral in the inner circumferential direction and the track of RL(1) may be spiral in the outer circumferential direction.

Furthermore, although the above embodiments have been described in detail in order to clearly describe the present invention, the present invention is not necessarily limited to the embodiments including all the described configurations. Moreover, it is possible to replace a part of the configuration of a certain embodiment with a configuration of other embodiment, and it is also possible to add the configuration of other embodiment to the configuration of a certain embodiment.

It should be further understood by those skilled in the art that although the foregoing description has been made on embodiments of the invention, the invention is not limited thereto and various changes and modifications may be made without departing from the spirit of the invention and the scope of the appended claims.

1. An optical disc apparatus recording and/or reproducing information on an optical disc, the optical disc comprising a reference layer having a spiral track added with address information, and a recording layer capable of recording and/or reproducing information in a predetermined depth position while following the track of the reference layer, the optical disc apparatus comprising:
a first light source emitting a first laser beam which is focused on the track of the reference layer; and
a second light source emitting a second laser beam which is focused on a predetermined depth position of the recording layer while following the track of the reference layer on which the first laser beam is focused, wherein
according to the depth position of the recording layer on which the second laser beam is focused, the first laser beam is focused on the track of a reference layer having a corresponding spiral direction, of two reference layers having the spiral directions of the track different from each other.

2. The optical disc apparatus according to claim 1, wherein when the second laser beam is focused on a predetermined depth position of the recording layer to record information in the recording layer, the first laser beam is focused on a track of a reference layer having a corresponding spiral direction so that the spiral direction may differ from that of an adjacent recording surface in a depth direction of the recording layer.

3. The optical disc apparatus according to claim 1, wherein when the second laser beam is focused in the first depth position of the recording layer and information is recorded or reproduced and thereafter the focusing position of the second laser beam is switched to a second depth position different from the first depth position, the focusing position of the first laser beam is moved from a predetermined reference layer to other reference layer having a different spiral direction.

4. The optical disc apparatus according to claim 1, wherein when the second laser beam is focused in the first depth position of the recording layer and information is recorded or reproduced and thereafter the focusing position of the second laser beam is switched to a second depth position different from the first depth position, the focusing position of the first laser beam is moved from a predetermined reference layer to other reference layer having a different spiral direction and thereafter the focusing position of the second laser beam is controlled so as to be switched to the second depth position of the recording layer.

5. The optical disc apparatus according to claim 1, wherein the first laser beam is focused on a predetermined area of the reference layer, so that management information indicative of a spiral direction of a recording surface formed in a predetermined depth position of the recording layer can be recorded or reproduced.

6. The optical disc apparatus according to claim 1, wherein the first laser beam is focused on a predetermined area of the reference layer, so that predetermined management information, which is modified each time information is recorded onto the recording layer, can be recorded or reproduced.

7. An optical disc capable of recording and/or reproducing information, the optical disc comprising a reference layer having a spiral track added with address information and a recording layer capable of recording and/or reproducing information in a predetermined depth position while following the track of the reference layer, wherein the reference layer comprises two layers having spiral directions of a track different from each other.

8. The optical disc according to claim 7, wherein the reference layer is capable of recording and reproducing information.

9. The optical disc according to claim 7, wherein management information indicative of a spiral direction of a recording surface formed in a predetermined depth position of the recording layer can be recorded or reproduced to or from the reference layer.

10. The optical disc according to claim 7, wherein predetermined management information, which is modified each time information is recorded onto the recording layer, can be recorded or reproduced to or from the reference layer.

11. A recording method for an optical disc apparatus recording information onto an optical disc, the optical disc comprising a reference layer having a spiral track added with address information and a recording layer capable of recording information in a predetermined depth position while following the track of the reference layer, the optical disc apparatus comprising:
a first light source emitting a first laser beam which is focused on the track of the reference layer; and
a second light source emitting a second laser beam which is focused on a predetermined depth position of the recording layer while following the track of the reference layer on which the first laser beam is focused, wherein
according to the depth position of the recording layer on which the second laser beam is focused, the first laser beam is focused on the track of a reference layer having a corresponding spiral direction, of two reference layers having the spiral directions of the track different from each other.

12. The recording method according to claim 11, wherein when the second laser beam is focused in the first depth position of the recording layer and information is recorded and thereafter the focusing position of the second laser beam is switched to a second depth position different from the first depth position, the focusing position of the first laser beam is moved from a predetermined reference layer to other reference layer having a different spiral direction.

13. A reproduction method for an optical disc apparatus recording information onto an optical disc, the optical disc comprising a reference layer having a spiral track added with address information and a recording layer capable of recording information in a predetermined depth position while following the track of the reference layer, the optical disc apparatus comprising:
a first light source emitting a first laser beam which is focused on the track of the reference layer; and
a second light source emitting a second laser beam which is focused on a predetermined depth position of the recording layer while following the track of the reference layer on which the first laser beam is focused, wherein
according to the depth position of the recording layer on which the second laser beam is focused, the first laser beam is focused on the track of a reference layer having a corresponding spiral direction, of two reference layers having the spiral directions of the track different from each other.

14. The reproduction method according to claim 13, when the second laser beam is focused in the first depth position of the recording layer and information is reproduced and thereafter the focusing position of the second laser beam is switched to a second depth position different from the first depth position, the focusing position of the first laser beam is moved from a predetermined reference layer to other reference layer having a different spiral direction.
